(19) United States
(12) Patent Application Publication
(10) Pub. No.: US 2025/0201238 A1
(43) Pub. Date: Jun. 19, 2025

(54) MATCHING APPARATUS, MATCHING METHOD, AND COMPUTER READABLE RECORDING MEDIUM

(71) Applicant: NEC Corporation, Minato-ku, Tokyo (JP)

(72) Inventors: Yuko NAKANISHI, Tokyo (JP); Akira GOTOH, Tokyo (JP); Shuji KOMEIJI, Tokyo (JP); Daichi NISHII, Tokyo (JP); Yuka ENJOJI, Tokyo (JP)

(73) Assignee: NEC Corporation, Minato-ku, Tokyo (JP)

(21) Appl. No.: 18/846,308

(22) PCT Filed: Mar. 17, 2022
(86) PCT No.: PCT/JP2022/012325

§ 371 Date: Sep. 12, 2024

(51) Int. Cl. G10L 15/08; G10L 25/63

(52) U.S. Cl. CPC G10L 15/08; G10L 25/63

(57) ABSTRACT

A matching apparatus includes: a data processing unit that identifies information of a user from input data for matching that is input by the user; and a matching processing unit that identifies sound data that matches the user by comparing the identified information with classification information that is associated with each sound data in advance.

### TECHNICAL FIELD

The present disclosure relates to a matching apparatus and a matching method for providing sound that matches a user, and further relates to a computer readable recording medium for realizing the matching apparatus and the matching method.

### BACKGROUND ART

In recent years, various matching services are provided via terminal devices such as smartphones along with the development of IT technologies. Representative examples of matching services are person-to-person matching services. In such a matching service, matching is performed with use of personal information expressed by text.

Also, matching services in which voice is used are provided in addition to matching services in which personal information is used. Patent Document 1 discloses an apparatus that performs matching processing using voice. When a user inputs his voice, the apparatus disclosed in Patent Document 1 generates voice classification information by classifying the input voice of the user with use of a machine learning model. Then, the apparatus disclosed in Patent Document 1 generates voice classification information (target matching voice classification information) regarding voice that matches the voice of the user with use of the voice classification information regarding the voice of the user.

As described above, according to the apparatus disclosed in Patent Document 1, it is possible to generate voice classification information that matches the voice of the user by merely letting the user input his voice. Therefore, if the apparatus disclosed in Patent Document 1 is applied to a game device, for example, guidance in a game can be given with voice that matches the player.

### LIST OF RELATED ART DOCUMENTS

### Patent Document

Patent document 1: Japanese Patent Laid-Open Publication No. 2021-144221

### SUMMARY OF INVENTION

### Problems to be Solved by the Invention

However, the apparatus disclosed in Patent Document 1 performs matching based on only a classification result of voice data that is input. Therefore, the apparatus disclosed in Patent Document 1 has a problem in that matching cannot be executed with consideration given to information other than voice, such as a condition input in the form of text, an emotion of the user, and the age of the user.

An example object of the present disclosure is to provide a matching apparatus, a matching method, and a computer readable recording medium with which it is possible to identify sound that matches a user by using information other than sound.

### Means for Solving the Problems

In order to achieve the above-described object, a matching apparatus according to an example aspect of the present disclosure includes:
a data processing unit that identifies information of a user from input data for matching that is input by the user; and
a matching processing unit that identifies sound data that matches the user by comparing the identified information with classification information that is associated with each sound data in advance.

In order to achieve the above-described object, a matching method according to an example aspect of the present disclosure includes:
identifying information of a user from input data for matching that is input by the user; and
identifying sound data that matches the user by comparing the identified information with classification information that is associated with each sound data in advance.

In order to achieve the above-described object, a computer readable recording medium according to an example aspect of the present disclosure is a computer readable recording medium that includes recorded thereon a program,
the program including instruction that cause a computer to carry out:
identifying information of a user from input data for matching that is input by the user; and
identifying sound data that matches the user by comparing the identified information with classification information that is associated with each sound data in advance.

### Advantageous Effects of the Invention

As described above, according to the present disclosure, it is possible to identify sound that matches a user by using information other than sound.

### BRIEF DESCRIPTION OF THE DRAWINGS

FIG. 1 is a configuration diagram illustrating the schematic configuration of a matching apparatus in the example embodiment.

FIG. 2 is a configuration diagram illustrating details of the configuration of the matching apparatus in the example embodiment.

FIG. 3 is a flow diagram illustrating the operations of the matching apparatus in the example embodiment.

FIG. 4 is a diagram schematically illustrating processing performed in Example 1.

FIG. 5 is a diagram schematically illustrating processing performed in Example 2.

FIG. 6 is a configuration diagram illustrating the variation of the example embodiment.

FIG. 7 is a block diagram illustrating an example of a computer that realizes the matching apparatus 10 according to the example embodiment.

### EXAMPLE EMBODIMENT

### Example Embodiment

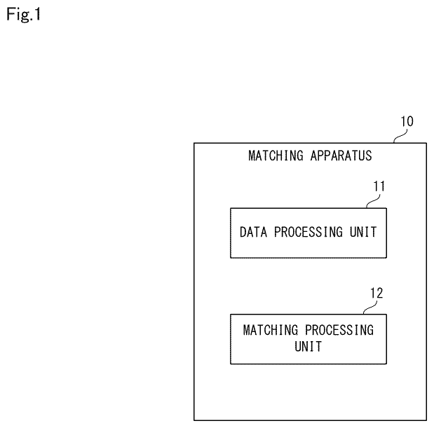

The following describes a matching apparatus, a matching method, and a program in an example embodiment with reference to FIGS. 1 to 7.

### [Apparatus Configuration]

First, the following describes a schematic configuration of a matching apparatus in the example embodiment with reference to FIG. 1. FIG. 1 is a configuration diagram illustrating the schematic configuration of a matching apparatus in the example embodiment.

A matching apparatus 10 in the example embodiment illustrated in FIG. 1 is an apparatus that identifies sound that matches a user with use of data input by the user. Here, “sound desired by the user” includes not only sound itself but also tone, sound quality, voice quality, sound range, etc.

As illustrated in FIG. 1, the matching apparatus 10 includes a data processing unit 11 and a matching processing unit 12. The data processing unit 11 identifies information of the user from input data for matching that is input by the user. The matching processing unit 12 identifies sound data that matches the user by comparing the identified information with classification information that is associated with each sound data in advance.

As described above, in the example embodiment, the matching apparatus 10 identifies information of the user from data input by the user and identifies sound data that matches the user by comparing the identified information of the user with classification information. Therefore, according to the matching apparatus 10, it is possible to identify sound that matches the user by using information other than sound.

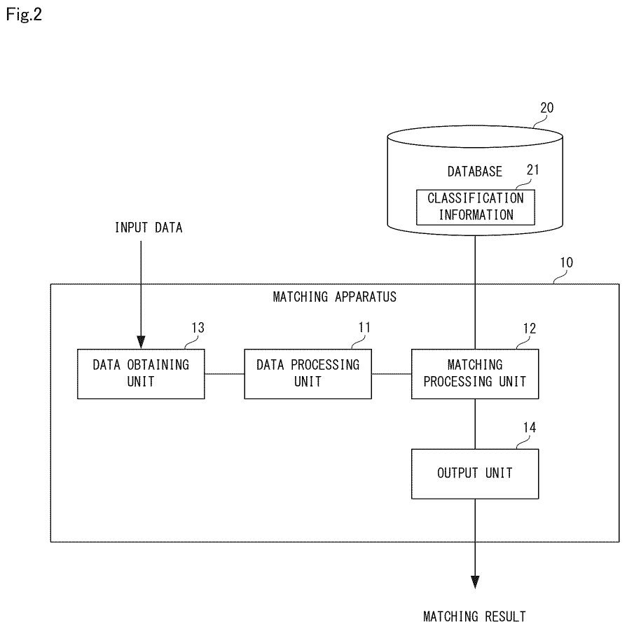

Next, the following specifically describes the configuration and functions of the matching apparatus 10 in an example embodiment 1 with reference to FIG. 2. FIG. 2 is a configuration diagram illustrating details of the configuration of the matching apparatus in the example embodiment.

As illustrated in FIG. 2, the matching apparatus 10 is connected to a database 20 via a network such as the Internet or a LAN (Local Area Network) in such a manner that data communication can be performed. Also, as illustrated in FIG. 2, the matching apparatus 10 in the example embodiment includes a data obtaining unit 13 and an output unit 14 in addition to the data processing unit 11 and the matching processing unit 12.

Classification information 21 is stored in the database 20. As described above, the classification information 21 is associated with each sound data in advance. If the sound data is voice data, examples of the classification information 21 include information characterizing the speaker, such as a voice actor whose voice is similar to the voice of the speaker, the residence of the speaker, voice quality of the speaker, and a group to which the speaker belongs. If the sound data is data other than voice data, examples of the classification information include a sound type, a frequency, and a sound volume. Each classification information is provided with an identifier of the sound data associated with the classification information.

The data obtaining unit 13 obtains input data of a user who is a matching target. Examples of the input data of the user include voice data of the user, an identifier of the user, personal information (sex, residence, etc.) of the user, and data indicating a preference of the user. Examples of the data indicating a preference of the user include data indicating a voice actor, an actor, a comedian, a singer, a sport, a food, etc., that the user likes. There is no particular limitation on the source from which the data obtaining unit 13 obtains the input data of the user. For example, the input data may be obtained from a system that uses the matching apparatus 10, such as a system that provides a person-to-person matching service or a system of a call center, which will be described later.

In the example embodiment, the data processing unit 11 first receives the input data of the user from the data obtaining unit 13, performs processing in accordance with the type of data included in the input data, and identifies information of the user.

For example, it is assumed that voice data of the user is included in the input data. In this case, the data processing unit 11 can perform voice recognition processing and identify a preference of the user as the information of the user from the result of the voice recognition processing.

Also, the data processing unit 11 can perform emotion analysis on the user by using the voice data and identify an emotion of the user as the information of the user. Furthermore, the data processing unit 11 can perform age analysis on the user in addition to or instead of the emotion analysis by using the voice data and identify the age of the user as the information of the user.

Examples of a method for identifying an emotion from voice data include a method in which a machine learning model is used. In this case, the machine learning model is generated by executing machine learning with use of voice data and a label representing an emotion corresponding to the voice data, as training data. Likewise, examples of a method for identifying an age from voice data include a method in which a machine learning model is used. In this case, the machine learning model is generated by executing machine learning with use of voice data and a label representing an age corresponding to the voice data, as training data.

Examples of a learning engine for machine learning include a neural network, a support vector machine, and a random forest. Also, k-means can be used as the learning engine when teacher data is not used.

When the input data includes data indicating a preference of the user, the data processing unit 11 identifies the preference from the input data, as the information of the user. Specifically, it is assumed that the input data includes text data indicating a preference of the user. In this case, the data processing unit 11 executes natural language processing on the text data by using a dictionary prepared in advance and identifies the preference of the user.

Furthermore, the data processing unit 11 can identify the user who is the speaker based on the result of the voice recognition processing. In this case, the data processing unit 11 can determine whether or not the identified user is registered in a specific list in advance. This aspect is advantageous when it is necessary to identify a person on a blacklist in the matching, for example.

The matching processing unit 12 compares the information of the user identified by the data processing unit 11 with the classification information 21 and identifies sound data that matches the user by using the result of comparison. For example, when a preference of the user is identified by the data processing unit 11, the matching processing unit 12 determines a degree of similarly between the preference of the user and the classification information 21 with respect to each sound data. Then, the matching processing unit 12 identifies sound data for which the determined degree of similarly satisfies a set condition.

When the emotion of the user is identified by the data processing unit 11, the matching processing unit 12 identifies classification information 21 that matches the identified emotion and identifies sound data associated with the identified classification information 21. When the age of the user is identified by the data processing unit 11, the matching processing unit 12 identifies classification information 21 that matches the identified age and identifies sound data associated with the identified classification information.

The output unit 14 outputs an identifier of the sound data identified by the matching processing unit 12. The identifier referred to here is an identifier given to the classification information 21 described above.

### [Apparatus Operations]

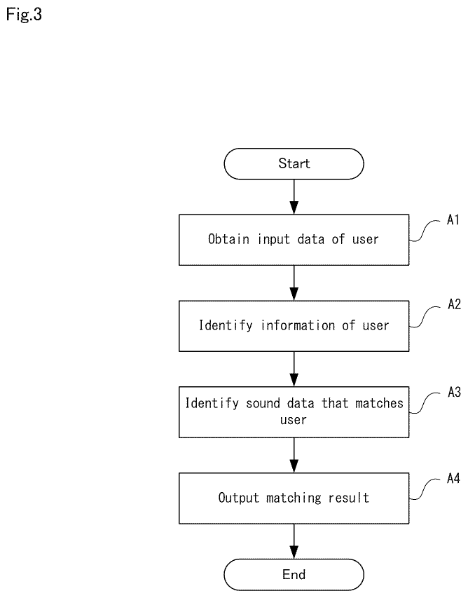

Next, the following describes operations of the matching apparatus in the example embodiment with reference to FIG. 3. FIG. 3 is a flow diagram illustrating the operations of the matching apparatus in the example embodiment. The following description refers to FIGS. 1 and 2 as appropriate. Also, in an example embodiment, a matching method is performed by causing the matching apparatus 10 to operate. Therefore, the following description of the operations of the matching apparatus 10 is given instead of a description of the matching method in the example embodiment.

As illustrated in FIG. 3, first, the data obtaining unit 13 obtains input data of a user who is a matching target (step A1). The data obtaining unit 13 gives the obtained input data to the data processing unit 11.

Next, the data processing unit 11 receives the input data obtained in step A1 and identifies information of the user from the received input data (step A2).

Next, the matching processing unit 12 compares the information of the user identified in step A2 with the classification information 21 stored in the database 20 and identifies sound data that matches the user by using the result of comparison (step A3). The classification information 21 is information associated with each sound data.

Thereafter, the output unit 14 outputs an identifier of the sound data identified in step A3, as a matching result (step A4).

### SPECIFIC EXAMPLES

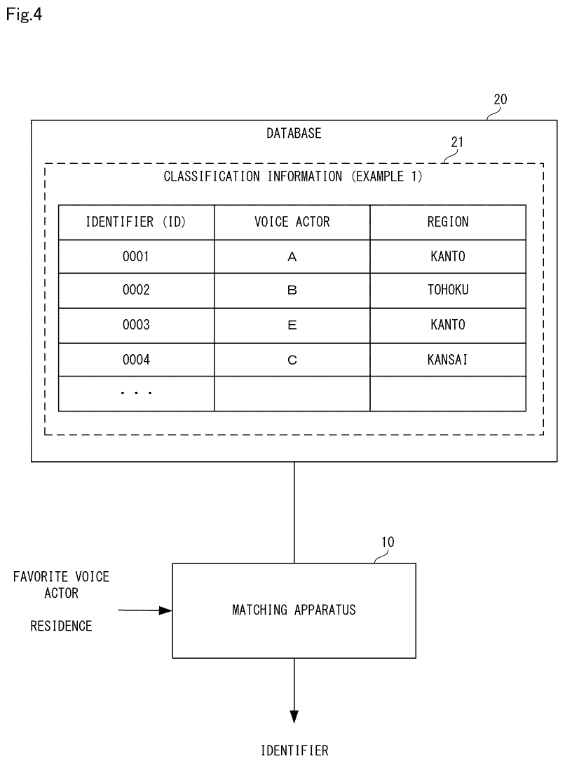

Here, the following describes specific examples of processing performed by the matching apparatus 10 in the example embodiment with respect to each application with reference to FIGS. 4 to 6. Also, the following description refers to FIGS. 1 to 3 as appropriate.

### Example 1

In Example 1, the matching apparatus 10 is used in a system that provides a person-to-person matching service. FIG. 4 is a diagram schematically illustrating processing performed in Example 1. In the example illustrated in FIG. 4, sound data is voice data. The user is a person who wants to perform matching.

In the classification information 21 illustrated in FIG. 4, each identifier functions as an identifier of voice data as well as an Example 1 of the speaker corresponding to the voice data. Also, in the classification information 21, “voice actor” indicates a voice actor whose voice is similar to the voice of the corresponding voice data, and “region” indicates the residence of the speaker corresponding to the voice data (see Example A, which will be described later).

As illustrated in FIG. 4, in Example 1, the data obtaining unit 13 obtains text data indicating the name of a voice actor whom the user likes and the residence of the user, as input data from the system described above.

The data processing unit 11 executes natural language processing on the obtained text data by using a dictionary prepared in advance and identifies the name of the voice actor whom the user likes and the residence of the user.

The matching processing unit 12 determines a degree of similarity between the preference (voice actor and residence) of the user and the classification information 21 with respect to each voice data (identifier) included in the data group 21. Specifically, when both the name of the voice actor and the residence match, the matching processing unit 12 determines that the degree of similarity is 1, when only the name of the voice actor matches, determines that the degree of similarity is 0.75, when only the residence matches, determines that the degree of similarity is 0.25, and when none of the name of the voice actor and the residence match, determines that the degree of similarity is 0.

Then, the matching processing unit 12 identifies voice data (identifier) for which the degree of similarly is the highest. Thereafter, the output unit 14 outputs the identifier of the voice data identified by the matching processing unit 12 to the system described above.

Upon receiving the identifier of the identified sound data, the system described above identifies a speaker corresponding to the identifier and proposes the identified speaker as a matching candidate for the user. As described above, the matching apparatus 10 is useful in the above-described system that provides a person-to-person matching service.

### Example 2

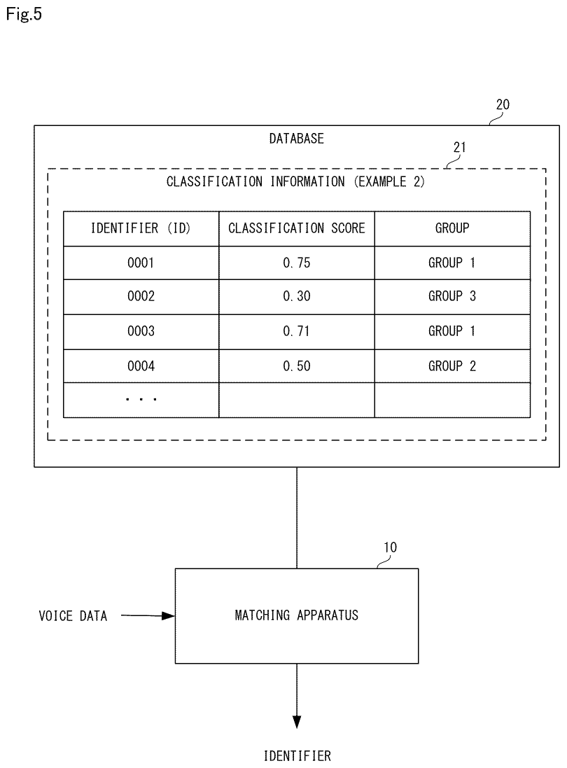

In Example 2, the matching apparatus 10 is used in a system of a call center. FIG. 5 is a diagram schematically illustrating processing performed in Example 2. In the example illustrated in FIG. 5 as well, sound data is voice data. The user is a person who is making an inquiry to the call center.

In the classification information 21 illustrated in FIG. 5, each identifier functions as an identifier of voice data as well as an identifier of the speaker corresponding to the voice data. In the example illustrated in FIG. 5, the speaker is an operator of the call center. In the classification information 21, “classification score” is calculated from the clearness of the voice of the operator and a business result of the operator, and the higher the clearness is and the higher the business result is, the classification score becomes higher (see Example B, which will be described later). “Group” indicates a group into which the corresponding voice data is classified according to the classification score, and there are a group 1 (A=0.7 or more and 1.0 or less), a group 2 (A=0.35 or more and less than 0.7), and a group 3 (A=0 or more and less than 0.35).

As illustrated in FIG. 5, in Example 2, the data obtaining unit 13 obtains voice data of the user as input data from the system described above.

The data processing unit 11 performs emotion analysis on the user by using the voice data and identifies the emotion of the user, or more specifically, a degree of anger as information of the user. Also, the data processing unit 11 performs age analysis on the user by using the voice data and identifies the age of the user as information of the user.

The matching processing unit 12 compares the degree of anger and the age of the user identified by the data processing unit 11 with the classification information 21 and identifies voice data that matches the user by using the result of comparison.

For example, it is assumed that the degree of anger and the age of the user are each identified as any of five levels 1 to 5. In this case, the matching processing unit 12 calculates a sum of the level of the degree of anger and the level of the age. When the sum is 8 to 10, the matching processing unit 12 identifies voice data that belongs to the group 1, when the sum is 5 to 7, identifies voice data that belongs to the group 2, and when the sum is 2 to 4, identifies voice data that belongs to the group 3.

Thereafter, the output unit 14 outputs an identifier of the voice data identified by the matching processing unit 12 to the system described above.

Upon receiving the identifier of the identified sound data, the system described above identifies an operator corresponding to the identifier and instructs the identified operator to reply to the user. As described above, with use of the matching apparatus 10, it is possible to apply an operator who can reply most appropriately to the user making an inquiry. The matching apparatus 10 is useful in the system of a call center described above.

Furthermore, in Example 2, the data processing unit 11 can identify the user who is the speaker based on the result of the voice recognition processing. In this case, the data processing unit 11 determines whether or not the identified user is a person registered in a blacklist prepared in advance. If it is that the user is registered in the blacklist, the matching processing unit 12 can identify voice data belonging to the group 1 described above without comparing the information of the user with the classification information 21.

### Variation

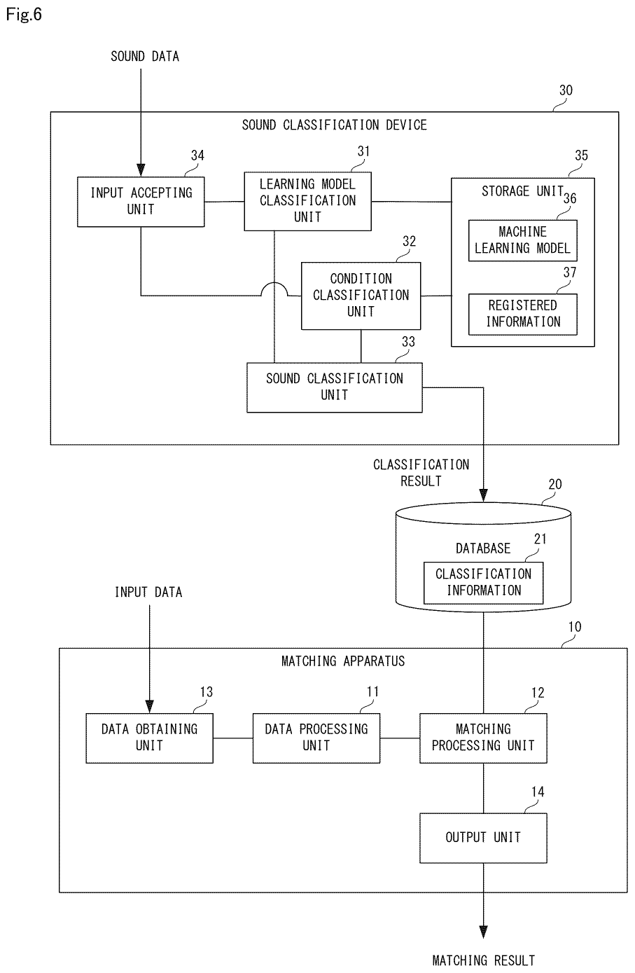

Next, the following describes a variation of the example embodiment. FIG. 6 is a configuration diagram illustrating the variation of the example embodiment. In the variation illustrated in FIG. 6, a sound classification device 30 for generating the classification information 21 is illustrated.

In the variation, the classification information 21 is obtained from first information and second information. The first information is obtained by inputting classification target sound data to a machine learning model 36. The machine learning model 36 is generated by performing machine learning with use of sound data and teacher data, which are training data. The second information is obtained by classifying the classification target sound data based on information (registered information 37) that is registered in advance. The following specifically describes the variation.

The sound classification device 10 illustrated in FIG. 6 is a device for classifying various sounds such as voice of a person, environmental sound, etc. As illustrated in FIG. 6, the sound classification device 30 includes a learning model classification unit 31, a condition classification unit 32, a sound classification unit 33, an input accepting unit 34, and a storage unit 35.

The input accepting unit 34 accepts input of classification target sound data and inputs the accepted sound data to the learning model classification unit 31 and the condition classification unit 32. The input accepting unit 34 may extract a feature value from the accepted sound data and input only the extracted feature value to the learning model classification unit 31 and the condition classification unit 32.

The storage unit 35 stores therein the machine learning model 36 used by the learning model classification unit 31 and the registered information 37 used by the condition classification unit 32.

In an example embodiment, the machine learning model 36 is a model that identifies a relationship between sound data and information characterizing the sound. Accordingly, information characterizing sound is used as teacher data that is used as training data. For example, if the sound data is voice data, examples of information characterizing the sound (voice) include the name of a person who has the voice, the pitch of the voice, the brightness of the voice, the clearness of the voice, and attributes (age and sex) of the person. If the sound data is data other than voice data, examples of information characterizing the sound include a sound type (explosive sound, fricative sound, chewing sound, or steady sound).

Here, specific examples of training data are given below. Note that instead of sound data, feature values of sound may also be used as training data.
Training data 1: (voice data A, voice actor A), (voice data B, voice actor B), (voice data C, voice actor C), . . .
Training data 2: (voice data A, clearness A), (voice data B, clearness B), (voice data C, clearness C), . . .
Training data 3: (sound data A, type A), (sound data B, type B), (sound data C, type C), . . .

In the case where the training data 1 is used, when voice data is input, the machine learning model 36 outputs a probability (a value from 0 to 1) that the input voice data corresponds to each of the voice actors A, B, C, etc. In this case, the learning model classification unit 31 identifies a voice actor for whom the probability is the highest, and outputs the identified voice actor as a classification result.

In the case where the training data 2 is used, the clearness is represented by values from 0 to 1, and accordingly, when voice data is input, the machine learning model 36 outputs a value corresponding to the input voice data as the clearness. In this case, the learning model classification unit 31 outputs the value output as the clearness as a classification result.

In the case where the training data 3 is used, when sound data is input, the machine learning model 36 outputs a probability (a value from 0 to 1) that the input sound data corresponds to each of the types A, B, and C, etc. In this case, the learning model classification unit 31 identifies a type for which the probability value is the largest, and outputs the identified type and the probability value as a classification result.

The learning model classification unit 31 inputs classification target sound data to the machine learning model 36 and outputs information (first information) characterizing the sound corresponding to the classification target sound data, or more specifically, a probability corresponding to each characteristic, as a classification result.

The registered information 37 is information that is registered in advance to classify sound data. If the sound data is voice data, examples of the registered information 37 include a business result of each person, an address of each person, a hobby of each person, personality of each person, and voice magnitude of each person. If the sound data is data other than voice data, examples of the registered information 37 include a location where each sound was generated, the volume of each sound, and the frequency of each sound.

The condition classification unit 32 compares the classification target sound data with the registered information 37, extracts information corresponding to the sound data, and outputs the extracted information as a classification result. Here, it is assumed that the sound data is voice data. In this case, it is assumed that an identifier of the speaker is added to the classification target voice data, and the registered information 37 is registered with respect to each identifier.

In this case, the condition classification unit 32 initially identifies the identifier added to the classification target sound data, from the classification target sound data. Then, the condition classification unit 32 compares the identified identifier with the registered information 37 registered with respect to each identifier, extracts registered information corresponding to the identified identifier, and outputs the extracted registered information (second information) as a classification result.

The sound classification unit 13 outputs, as a classification result, information including the classification result output from the learning model classification unit 31 and the classification result output from the condition classification unit 32. The output classification result is registered as the classification information 21 in the database 20.

Here, the following describes specific examples of processing performed by the sound classification device 10. In the following examples A and B, classification target sound data is voice data.

### Example A

In Example A, the machine learning model 36 is obtained by performing machine learning with use of the training data 1 described above and outputs a probability (a value from 0 to 1) that the input voice data corresponds to each of the voice actors A, B, C, etc. Therefore, the learning model classification unit 31 identifies a voice actor for whom the probability is the highest from the output result and outputs the name of the identified voice actor as a classification result.

Also, in Example A, a region (e.g., Kanto, Tohoku, Tokai, etc.) of residence is registered as the registered information 37 with respect to each identifier of a person. The condition classification unit 32 identifies an identifier of the speaker added to the classification target voice data, from the classification target voice data, compares the identified identifier with the registered information 37, and outputs the name of a region corresponding to the identified identifier.

The sound classification unit 33 outputs, as a classification result, a combination of the name of the voice actor output from the learning model classification unit 31 and the name of the region output from the condition classification unit 32. Examples of the classification result include “voice actor A+Kanto” and “voice actor B+Tohoku”. Thereafter, the sound classification unit 13 outputs the name of the corresponding voice actor and the name of the corresponding region as the final classification result to the database 20. Consequently, the name of the voice actor and the name of the region are registered in association with each other as classification information in the database 20 as illustrated in FIG. 4.

### Example B

In Example B, the machine learning model 36 is obtained by performing machine learning with use of the training data 2 described above, and when classification target voice data is input, the learning model classification unit 31 outputs a value x₁ indicating clearness.

Also, in Example B, a business result x₂ of each person is registered as the registered information 37. In this case, it is assumed that the business result is expressed by normalizing an order to a value from 0 to 1. For example, if the business result is indicated by the 1st through 45th places, the 1st place corresponds to x₂=1, the 12th place corresponds to x₂=0.75, and the 45th place corresponds to x₂=0.

The condition classification unit 32 identifies an identifier of the speaker added to the classification target voice data, from the classification target voice data, compares the identified identifier with the business result registered with respect to each identifier, and outputs a business result x₂ corresponding to the identified identifier.

The sound classification unit 33 calculates a classification score A by inputting the output from the learning model classification unit 31 and the output from the condition classification unit 12 to Formula 1 shown below. In Formula 1, w₁ and w₂ are weighting factors. Values of the weighting factors are set as appropriate according to the conditions or the like.

$$A = {w}_{1} {x}_{1} + {w}_{2} {x}_{2} \qquad ( Formula 1 )$$

Then, the sound classification unit 33 classifies, with respect to each identifier, the classification target voice data into any of groups set in advance, according to the calculated classification score A. For example, it is assumed that x₁=0.7, x₂=0.80, w₁=0.3, and w₂=0.7. In this case, the classification score A is 0.77. If the groups are set as follows: a group 1 (A=0.7 or more and 1.0 or less), a group 2 (A=0.35 or more and less than 0.7), and a group 3 (A=0 or more and less than 0.35), the sound classification unit 13 determines that the voice data belongs to the group 1.

Thereafter, the sound classification unit 13 outputs the corresponding identifier and the group number as a final classification result to the database 20. Consequently, the identification number and the group number are registered in association with each other in the database 20 as illustrated in FIG. 5.

### Effects of Embodiment

As described above, in an example embodiment, the matching apparatus 10 identifies information of a user from data input by the user and identifies sound data that matches the user by comparing the identified information of the user with the classification information 21. Therefore, according to the matching apparatus 10, it is possible to identify sound that matches the user by using information other than sound.

Also, the classification information 21 is obtained by executing classification with use of the machine learning model 36 and executing classification based on the registered information 37. Therefore, in the example embodiment, sound data that matches the user is identified not relying on only machine learning, and therefore, even if it is not possible to prepare a large amount of training data of various types, it is possible to obtain appropriate classification information 21.

### [Program]

A program in the example embodiment is any program that causes a computer to execute steps A1 to A4 illustrated in FIG. 3. The matching apparatus and the matching method in the present example embodiment can be realized, by installing the program in the computer and executing the installed program. In this case, the processor of the computer functions as the data processing unit 11, the matching processing unit 12, the data obtaining unit 13, and the output unit 14 to perform processing. The computer may be a general-purpose PC, a smartphone, or a tablet terminal device.

The program in the example embodiment may be executed by a computer system that is constructed of a plurality of computers. In this case, each computer may function as any of the data processing unit 11, the matching processing unit 12, the data obtaining unit 13, and the output unit 14.

### [Physical Configuration]

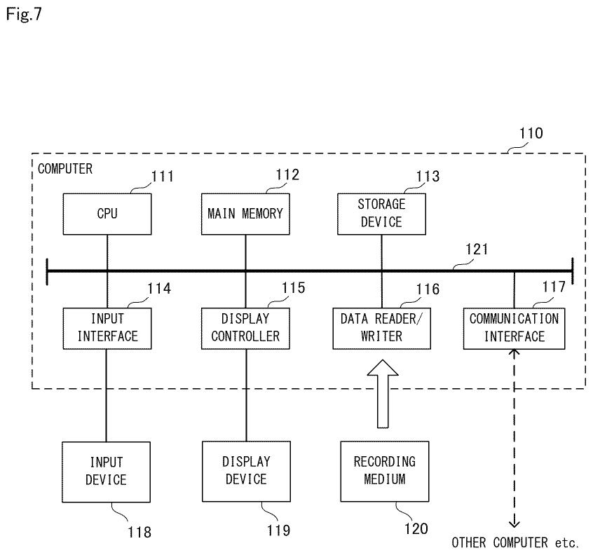

Using FIG. 7, the following describes a computer that realizes the matching apparatus 10 by executing the program according to the example embodiment. FIG. 7 is a block diagram illustrating an example of a computer that realizes the matching apparatus 10 according to the example embodiment.

As illustrated in FIG. 7, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the first and second example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the matching apparatus 10 according to the example embodiment can also be realized by using items of hardware correspond to the components rather than the computer in which the program is installed. Furthermore, a part of the matching apparatus 10 may be realized by the program, and the remaining part of the matching apparatus 10 may be realized by hardware.

A part or an entirety of the above-described example embodiment can be represented by (Supplementary Note 1) to (Supplementary Note 15) described below but is not limited to the description below.

### Supplementary Note 1

A matching apparatus according to an example aspect of the present disclosure includes:
a data processing unit that identifies information of a user from input data for matching that is input by the user; and
a matching processing unit that identifies sound data that matches the user by comparing the identified information with classification information that is associated with each sound data in advance.

### Supplementary Note 2

The matching apparatus according to supplementary note 1,
wherein the classification information is obtained from first information and second information, the first information being obtained by inputting classification target sound data to a machine learning model generated by performing machine learning with use of sound data and teacher data, which are training data, and the second information being obtained by classifying the classification target sound data based on information registered in advance.

### Supplementary Note 3

The matching apparatus according to supplementary note 1 or 2,
wherein the input data includes data indicating a preference of the user,
the data processing means identifies the preference of the user from the input data, as the information of the user, and
the matching processing unit determines a degree of similarity between the preference of the user and the classification information with respect to each sound data classified in advance, and identifies sound data for which the determined degree of similarity satisfies a set condition.

### Supplementary Note 4

The matching apparatus according to supplementary note 1 or 2,
wherein the input data is voice data of the user,
the data processing unit identifies, as the information of the user, an emotion of the user from the input data that is the voice data by performing emotion analysis on the user, and
the matching processing unit identifies the sound data that matches the user based on the identified emotion of the user.

### Supplementary Note 5

The matching apparatus according to supplementary note 1 or 2,
wherein the input data is voice data of the user,
the data processing unit identifies, as the information of the user, an age of the user from the input data that is the voice data by performing age analysis on the user, and
the matching processing unit identifies the sound data that matches the user based on the identified age of the user.

### Supplementary Note 6

A matching method comprising:
identifying information of a user from input data for matching that is input by the user; and
identifying sound data that matches the user by comparing the identified information with classification information that is associated with each sound data in advance.

### Supplementary Note 7

The matching method according to supplementary note 6,
wherein the classification information is obtained from first information and second information, the first information being obtained by inputting classification target sound data to a machine learning model generated by performing machine learning with use of sound data and teacher data, which are training data, and the second information being obtained by classifying the classification target sound data based on information registered in advance.

### Supplementary Note 8

The matching method according to supplementary note 6 or 7,
wherein the input data includes data indicating a preference of the user,
in the identifying information of the user, the preference of the user is identified from the input data, as the information of the user, and
in the identifying sound data that matches the user, a degree of similarity between the preference of the user and the classification information is determined with respect to each sound data classified in advance, and sound data for which the determined degree of similarity satisfies a set condition is identified.

### Supplementary Note 9

The matching method according to supplementary note 6 or 7,
wherein the input data is voice data of the user,
in the identifying information of the user, an emotion of the user is identified as the information of the user from the input data that is the voice data by performing emotion analysis on the user, and
in the identifying sound data that matches the user, the sound data that matches the user is identified based on the identified emotion of the user.

### Supplementary Note 10

The matching method according to supplementary note 6 or 7,
wherein the input data is voice data of the user,
in the identifying information of the user, an age of the user is identified as the information of the user from the input data that is the voice data by performing age analysis on the user, and
in the identifying sound data that matches the user, the sound data that matches the user is identified based on the identified age of the user.

### Supplementary Note 11

A computer readable recording medium that includes a program recorded thereon, the program including instructions that cause a computer to:
identify information of a user from input data for matching that is input by the user; and
identify sound data that matches the user by comparing the identified information with classification information that is associated with each sound data in advance.

### Supplementary Note 12

The computer readable recording medium according to supplementary note 11,
wherein the classification information is obtained from first information and second information, the first information being obtained by inputting classification target sound data to a machine learning model generated by performing machine learning with use of sound data and teacher data, which are training data, and the second information being obtained by classifying the classification target sound data based on information registered in advance.

### Supplementary Note 13

The computer readable recording medium according to supplementary note 11 or 12,
wherein the input data includes data indicating a preference of the user,
in identifying information of the user, the preference of the user is identified from the input data, as the information of the user, and
in identifying sound data that matches the user, a degree of similarity between the preference of the user and the classification information is determined with respect to each sound data classified in advance, and sound data for which the determined degree of similarity satisfies a set condition is identified.

### Supplementary Note 14

The computer readable recording medium according to supplementary note 11 or 12,
wherein the input data is voice data of the user,
in identifying information of the user, an emotion of the user is identified as the information of the user from the input data that is the voice data by performing emotion analysis on the user, and
in identifying sound data that matches the user, the sound data that matches the user is identified based on the identified emotion of the user.

### Supplementary Note 15

The computer readable recording medium according to supplementary note 11 or 12,
wherein the input data is voice data of the user,
in identifying information of the user, an age of the user is identified as the information of the user from the input data that is the voice data by performing age analysis on the user, and
in identifying sound data that matches the user, the sound data that matches the user is identified based on the identified age of the user.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

The data processing apparatus according to the present disclosure can allow only user with data use authorization to process data. The data processing apparatus according to the present disclosure can be used in a system that safely handles data for each user.

### REFERENCE SIGNS LIST

10 Matching apparatus
11 Data processing unit
12 Matching processing unit
13 Data obtaining unit
14 Output unit
20 Database
21 Classification information
30 Sound classification device
31 Learning model classification unit
32 Condition classification unit
33 Sound classification unit
34 Input accepting unit
35 Storage unit
36 Machine learning model
37 Registered information
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A matching apparatus comprising:
at least one memory storing instructions; and
at least one processor configured to execute the instructions to:
identify information of a user from input data for matching that is input by the user; and
identify sound data that matches the user by comparing the identified information with classification information that is associated with each sound data in advance.

2. The matching apparatus according to claim 1,
wherein the classification information is obtained from first information and second information, the first information being obtained by inputting classification target sound data to a machine learning model generated by performing machine learning with use of sound data and teacher data, which are training data, and the second information being obtained by classifying the classification target sound data based on information registered in advance.

3. The matching apparatus according to claim 1,
wherein the input data includes data indicating a preference of the user,
the one or more processors further;
identifies the preference of the user from the input data, as the information of the user, and
determines a degree of similarity between the preference of the user and the classification information with respect to each sound data classified in advance, and identifies sound data for which the determined degree of similarity satisfies a set condition.

4. The matching apparatus according to claim 1,
wherein the input data is voice data of the user,
the one or more processors further;
identifies, as the information of the user, an emotion of the user from the input data that is the voice data by performing emotion analysis on the user, and
identifies the sound data that matches the user based on the identified emotion of the user.

5. The matching apparatus according to claim 1,
wherein the input data is voice data of the user,
the one or more processors further;
identifies, as the information of the user, an age of the user from the input data that is the voice data by performing age analysis on the user, and
identifies the sound data that matches the user based on the identified age of the user.

6. A matching method comprising:
identifying information of a user from input data for matching that is input by the user; and
identifying sound data that matches the user by comparing the identified information with classification information that is associated with each sound data in advance.

7. The matching method according to claim 6,
wherein the classification information is obtained from first information and second information, the first information being obtained by inputting classification target sound data to a machine learning model generated by performing machine learning with use of sound data and teacher data, which are training data, and the second information being obtained by classifying the classification target sound data based on information registered in advance.

8. The matching method according to claim 6,
wherein the input data includes data indicating a preference of the user,
in the identifying information of the user, the preference of the user is identified from the input data, as the information of the user, and
in the identifying sound data that matches the user, a degree of similarity between the preference of the user and the classification information is determined with respect to each sound data classified in advance, and sound data for which the determined degree of similarity satisfies a set condition is identified.

9. The matching method according to claim 6,
wherein the input data is voice data of the user,
in the identifying information of the user, an emotion of the user is identified as the information of the user from the input data that is the voice data by performing emotion analysis on the user, and
in the identifying sound data that matches the user, the sound data that matches the user is identified based on the identified emotion of the user.

10. The matching method according to claim 6,
wherein the input data is voice data of the user,
in the identifying information of the user, an age of the user is identified as the information of the user from the input data that is the voice data by performing age analysis on the user, and
in the identifying sound data that matches the user, the sound data that matches the user is identified based on the identified age of the user.

11. A non-transitory computer readable recording medium that includes a program recorded thereon, the program including instructions that cause a computer to:
identify information of a user from input data for matching that is input by the user; and
identify sound data that matches the user by comparing the identified information with classification information that is associated with each sound data in advance.

12. The non-transitory computer readable recording medium according to claim 11,
wherein the classification information is obtained from first information and second information, the first information being obtained by inputting classification target sound data to a machine learning model generated by performing machine learning with use of sound data and teacher data, which are training data, and the second information being obtained by classifying the classification target sound data based on information registered in advance.

13. The non-transitory computer readable recording medium according to claim 11,
wherein the input data includes data indicating a preference of the user,
in identifying information of the user, the preference of the user is identified from the input data, as the information of the user, and
in identifying sound data that matches the user, a degree of similarity between the preference of the user and the classification information is determined with respect to each sound data classified in advance, and sound data for which the determined degree of similarity satisfies a set condition is identified.

14. The non-transitory computer readable recording medium according to claim 11,
wherein the input data is voice data of the user,
in identifying information of the user, an emotion of the user is identified as the information of the user from the input data that is the voice data by performing emotion analysis on the user, and
in identifying sound data that matches the user, the sound data that matches the user is identified based on the identified emotion of the user.

15. The non-transitory computer readable recording medium according to claim 11,
wherein the input data is voice data of the user,
in identifying information of the user, an age of the user is identified as the information of the user from the input data that is the voice data by performing age analysis on the user, and
in identifying sound data that matches the user, the sound data that matches the user is identified based on the identified age of the user.
